(19) United States
(12) Patent Application Publication
(10) Pub. No.: US 2025/0272181 A1
(43) Pub. Date: Aug. 28, 2025

(54) DYNAMIC GENERATION OF RUNBOOKS

(71) Applicant: Oracle International Corporation, Redwood Shores, CA (US)

(72) Inventors: Arnaud Delamare, Zurich (CH); Louis Faucon, Zurich (CH); Alexander Weld, Mountain View, CA (US); Sungpack Hong, Palo Alto, CA (US); Hassan Chafi, San Mateo, CA (US)

(21) Appl. No.: 18/586,763

(22) Filed: Feb. 26, 2024

(51) Int. Cl. G06F 11/07

(52) U.S. Cl. CPC G06F 11/0793; G06F 11/0709; G06F 11/0775

(57) ABSTRACT

The present disclosure relates to dynamically generating incident-remediation runbooks. An input configuration may be parsed, where the input configuration specifies a plurality of interface component sequences. A context comprising a plurality of context variable may be initialized. A dynamic runbook may be generated based at least in part on the input configuration and the context. A value of a particular context variable from the context may be modified to comprise an updated value. In response to modifying the value of the particular context variable, the dynamic runbook may be modified to comprise one or more interface components corresponding to one or more of the plurality of interface component sequences.

### TECHNICAL FIELD

The present disclosure relates to generating runbooks for incident management in computer systems.

### BACKGROUND

Runbooks are an important tool in cloud application monitoring and incident management. Cloud applications employ monitoring and notification systems that detect an incident and notify an on-call engineer (OCE) so that steps may be taken to remediate the incident. To do so, the OCE may consult a runbook. A runbook is a document that contains a set of guidelines and procedures for emergency maintenance of a system such as a cloud application. A runbook can provide instructions that OCEs, dev-ops engineers, system administrators, or other information technology (IT) professionals can use to perform various tasks related to system maintenance, troubleshooting, and recovery. A runbook may contain several sets of instructions that are relevant to different situations, so the runbook can present questions and conditional statements that guide an on-call engineer to the correct procedures for resolving a particular incident.

While useful, a runbook is simply a static document that is not linked in real-time with its associated system. Thus, runbooks are often out-of-date or even incomplete, such as if a runbook was written for a previous version of a system. This potential obsolescence makes runbooks unreliable to OCEs that are less familiar with the system being maintained. In addition, when a runbook uses conditional branching to account for different types of failures (e.g., if the system returns error code Y, then follow procedure A; otherwise follow procedure B), each branching set of instructions may have its own paragraph(s) of procedures to follow, each of which may in turn have its own conditional branches, and so on. Thus, the instructions may quickly become complicated and hard to follow. In addition, because runbooks include only static text, an OCE cannot directly implement a runbook's procedures in a system, so the OCE has to go back and forth between consulting the runbook and interacting with the system. The OCE may be forced to copy and paste commands from the runbook, which is slow, error-prone, and tedious.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram depicting a network environment.

FIG. 2 is a block diagram that illustrates an example of a system for generating a dynamic runbook implemented.

FIG. 3 is a flow diagram that depicts an example of the operation of a portion of a runbook generation engine.

FIG. 4 is a block diagram that illustrates a computer system upon which an embodiment of the invention may be implemented.

FIG. 5 is a block diagram of a basic software system a that may be employed for controlling the operation of a computing system.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

The present disclosure relates to dynamically generating incident-remediation runbooks. A system expert may create an input configuration that may describe workflows for resolving various incidents within a monitored system, such as a cloud application. A dynamic runbook may be generated based on the input configuration, a current state of the monitored system, and inputs provided by a user tasked with resolving an incident. The user may answer prompts provided by the dynamic runbook to pinpoint the failure and then follow a resulting set of instructions to attempt to resolve the failure.

A dynamic runbook may be generated using an input configuration. An input configuration may define what components a dynamic runbook can display, what operations the dynamic runbook can perform, and under which conditions the dynamic runbook can display these components and perform these operations. In some examples, the input configuration could be created by an author who is knowledgeable and experienced with a monitored system. That way, the author may ensure that the input configuration includes procedures that are relevant to any and all types of incidents that the monitored system may face. The input configuration may be written in many different formats including, for example, JavaScript Object Notation (JSON), YAML, or other data serialization language. The input configuration may therefore be created without knowledge of a programming language. In some implementations, the input configuration may be included in a text file. The input configuration may be platform-agnostic so that it may be used to generate dynamic runbooks on a variety of different platforms. Thus, the configuration and the visualization of the dynamic runbook are decoupled.

A runbook generation engine may generate a dynamic runbook based on an input configuration, on user input, on input from one or more external services, and on a current state of the monitored system. The runbook generation engine may control when interface components defined in the input configuration are displayed in the dynamic runbook. An interface component may be an applet or component that is responsible for performing a particular task within the runbook. The runbook generation engine may determine when to display or to hide an interface component or a group of related interface components-a “sequence” of interface components-based on a condition defined in the input configuration. This condition may be based on inputs from the user or from an external service.

The dynamic runbook generated by the runbook generation engine may include various interface components, each of which may be responsible for performing a particular task. For example, a dynamic runbook may include an interface component that displays information about a specified support ticket. Using these interface components, a dynamic runbook may, for example, receive input from a user, receive input from one or more external services, output custom instructions based on input from the user and/or external services, conditionally generate sequences of instructions, and issue requests and commands to external services. The dynamic runbook may be displayed in a dynamic environment such as, for example, a website, an interactive notebook interface, or an application program with a graphical user interface.

Once generated, the dynamic runbook may show basic information about the incident. For example, the dynamic runbook may show a support ticket number associated with the incident, a date and time at which the incident was detected or reported, an application affected by the incident, a tenancy affected by the incident, and potentially other information.

The dynamic runbook may also display generic information about the application affected by the incident and about any external services used by the application. For instance, the dynamic runbook may display logs generated by the application at the time of the incident and the status of each external service used by the application.

The dynamic runbook may then enable a user to determine a type of the incident or a likely cause of the incident. As an example, the dynamic runbook may present an incident type selector like a dropdown menu; the user may select an incident type from a prepopulated list presented by the dynamic runbook. Based on the selected incident type, the dynamic runbook may dynamically display one or more interface components that display new information and enable the user to refine a classification of the incident.

Once the incident has been properly classified, the dynamic runbook may display possible actions that the user may take to resolve the incident. For example, the dynamic runbook can enable the user to create a support ticket to repair a failure underlying the incident, to restart an external service that is unreachable or malfunctioning, to increase an improperly low timeout limit, to increase resources available to some service associated with the application, or to perform any action defined in the input configuration for the relevant type of incident.

The dynamic runbook therefore solves issues found in conventional, non-dynamic runbooks. The dynamic runbook may be customized based on input received from a user or an external service. The dynamic runbook may include custom instructions, as well as custom sequences of instructions that may be conditional—for example, when the dynamic runbook instructs a user to run a certain command, the dynamic runbook may replace arguments of that command with actual values relevant to a current situation, instead of simply displaying placeholder variable names. In addition, the dynamic runbook can enable a user to fully resolve the incident within the dynamic runbook-including interacting with external services-without opening a different application or performing operations outside of the dynamic runbook. Dynamic runbooks may also be easily configurable and modifiable via the input configuration, making dynamic runbooks less susceptible to obsolescence than conventional runbooks. Outdated instructions may also be more easily detectable because the code that interacts with external services may be verified and/or tested.

### System Overview

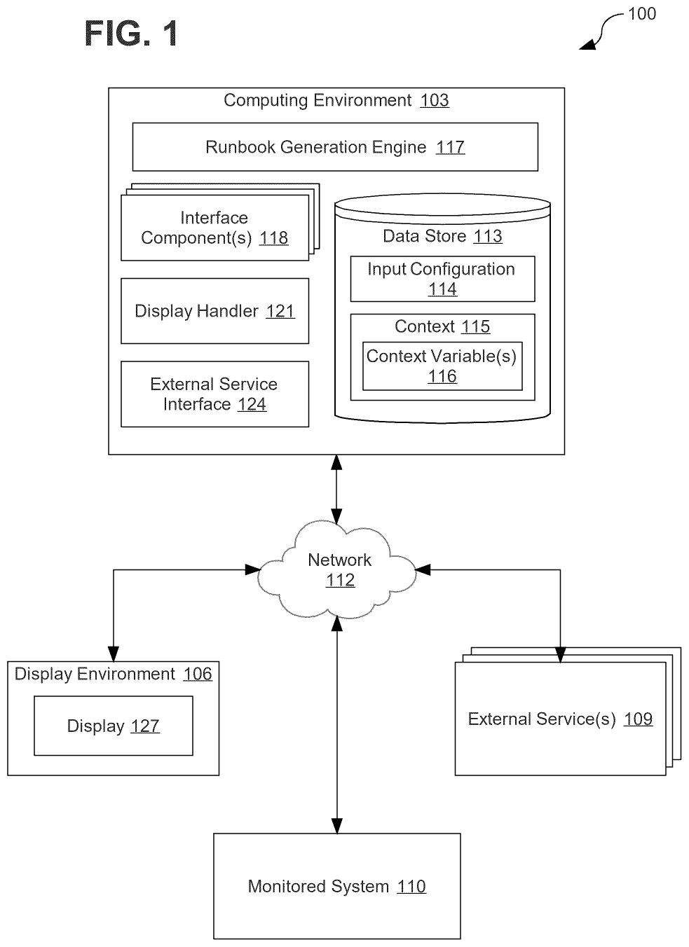

FIG. 1 is a block diagram depicting a network environment 100. The network environment 100 may include a computing environment 103, a display environment 106, one or more external services 109, a monitored system 110, and potentially other components in communication via a network 112.

The network 112 may include the Internet, intranets, extranets, wide area networks (WANs), local area networks (LANs), wired networks, wireless networks, other suitable networks, or any combination of two or more such networks. The networks may include satellite networks, cable networks, Ethernet networks, and other types of networks.

The computing environment 103 may include a computing device, such as a server computer, that provides computing capabilities. Alternatively, the computing environment 103 may employ multiple computing devices that are arranged in one or more server banks or computer banks. In one example, the computing devices may be located in a single installation. In another example, the computing devices for the computing environment 103 may be distributed among multiple different geographical locations. In one case, the computing environment 103 may include multiple computing devices that together may form a hosted computing resource or a grid computing resource. In addition, the computing environment 103 may operate as an elastic computing resource where the allotted capacity of computing-related resources, such as processing resources, network resources, and storage resources, may vary over time. In other examples, the computing environment 103 may include or be operated as one or more virtualized computer instances that may be executed to perform the functionality that is described herein.

Various data may be stored in a data store 113 that may be accessible to the computing environment 103. The data store 113 may be representative of a plurality of data stores 113. The data stored in the data store 113 may be associated with the operation of the various applications or functional entities described below. Data stored in the data store may include, for example, input configuration 114, context 115, context variable(s) 116, and various other types of data.

In addition, various applications or other functionality may be executed in the computing environment 103. Components executed in the computing environment 103 may include runbook generation engine 117, interface component(s) 118, display handler 121, external service interface 124, and other applications, services, processes, systems, engines, or functionality not discussed in detail herein.

### Runbook Generation Engine

The runbook generation engine 117 may generate and modify a dynamic runbook. The runbook generation engine 117 may parse an input configuration 114 to identify various interface components 118 that could be displayed in the dynamic runbook, which may be grouped into sequences. The runbook generation engine 117 may initialize a context 115 and check whether data stored therein has been modified. The runbook generation engine 117 may evaluate conditions for displaying or hiding the sequences of interface components 118 in the dynamic runbook using the data stored in the context 115. Based on this evaluation, the runbook generation engine 117 may instruct the display handler 121 to display or hide one or more sequences of interface components 118, as applicable.

### Input Configuration

The input configuration 114 may comprise a specification of one or more sequences interface components 118 that a dynamic runbook may be configured to display. The input configuration 114 may also define display conditions based on which the one or more interface components 118 sequences may be displayed. The input configuration 114 may be a file written in a data serialization language such as JSON or YAML, for example.

### Context

The context 115 may be a shared and modifiable repository of global information that may be accessible by the interface components 118. The context 115 may be a generic key-value store or other suitable data structure. The information included in the context 115 may include one or more context variables 116. The context variables 116 may have arbitrary values, but in some implementations the values may call for serialization and deserialization. The context 115 may be initialized by the runbook generation engine 117 using, for example, a set of predefined values for the context variables 116. This set of predefined values may represent an initial state of the dynamic runbook and may be defined in the input configuration 114, in some implementations. The context variables 116 included in the context 115 may represent, for instance, usernames, identifiers, inputs received from a user or external service 109, statuses associated with various entities or processes, information used to access an external service 109, and other information relevant to a dynamic runbook.

The runbook generation engine 117 may check the context 115 for modifications to the context variables 116. If the runbook generation engine 117 determines that one of the context variables 116 has been modified since a previous check of the context 115. If so, the runbook generation engine 117 can determine whether a display condition for any sequence of interface components 118 defined in the input configuration 114 has been satisfied by the modified context variable 116. The runbook generation engine 117 may then instruct the display handler 121 to update the dynamic runbook accordingly.

### Interface Components

An interface component 118 may be a dynamically-rendered, self-contained, and parameterized element of a dynamic runbook that may display information, receive input from a user, or interact with an external service 109. For example, an interface component 118 could be a text field that enables a user to input text data. As another example, an interface component 118 could be a container that displays event logs obtained from the monitored system 110 or an external service 109. As an additional example, an interface component 118 could be an embedded webpage that displays information from and/or enables a user to interact with an external service 109. In some implementations, each interface component 118 may include or have access to data storage to retain data used in the execution of that interface component 118.

An interface component 118 may retrieve and modify the value of a context variable 116 from the context 115. The value of a context variable 116 from the context 115 may be retrieved and modified by an interface component 118. As an example, an interface component 118 may retrieve a ticket number associated with a particular support ticket from the context 115. The interface component 118 may use the ticket number to request information about the support ticket from an external service 109 that manages support tickets for the monitored system 110. In response, the interface component 118 may receive information about the support ticket, including the support ticket's current status. The interface component 118 may modify the value of a “ticket status” context variable 116 in the context 115 to reflect that current status.

In some implementations, the interface components 118 may be useable in various different dynamic runbooks. Thus, when an input configuration 114 is created (or modified), a plurality of interface components 118 may be available for use in a corresponding dynamic runbook. The author of the input configuration 114 may select at least a subset of the available interface components 118 that are appropriate for that dynamic runbook.

### Sequences of Interface Components and Display Conditions

A sequence of one or more interface components 118 may be displayed in the dynamic runbook based on a display condition. The runbook generation engine 117 may determine that a display condition defined in the input configuration 114 is satisfied. The runbook generation engine 117 may then instruct the display handler 121 to display a corresponding list of interface components 118 in the dynamic runbook. Likewise, when the runbook generation engine 117 determines that the display condition a currently displayed sequence of interface components 118 is no longer satisfied, the runbook generation engine 117 may instruct the display handler 121 to hide (that is, cease displaying) the sequence of interface components 118 in the dynamic runbook. All interface components 118 of a sequence may be displayed when the sequence's display condition is satisfied and hidden when the display condition is not satisfied. In some implementations, the runbook generation engine 117 may require an input configuration 114 to include at least one sequence of interface components 118 without a display condition. That way, at least one sequence of interface components 118 may be displayed when the dynamic runbook is initially generated, before the context 115 is initialized.

A display condition may include binary expression that depends on a value from the context 115. Thus, an interface component 118 sequence's display condition may be based on, for instance, the value of a particular context variable 116 from the context 115. A display condition may involve testing whether a context variable 116 is set, testing against a specified value of a context variable 116, and any Boolean combination of such conditions.

To illustrate, the runbook generation engine 117 may instruct the display handler 121 to display the interface component 118 sequence when the runbook generation engine 117 detects that the particular context variable 116 has a specified value. This may occur if the particular context variable 116 has that value when the dynamic runbook is initially generated, or if the particular context variable 116 is modified to have that value. As an example, an interface component 118 may update a “ticket status” context variable 116 to reflect that particular support ticket is “In Progress”. In response, the runbook generation engine 117 may trigger display of an interface component 118 sequence whose display condition specifies a value of “In Progress” for the “ticket status” context variable 116. In some cases, an interface component 118 updating a particular context variable 116 may satisfy the display condition of another interface component 118 (or cause it to no longer be satisfied), in turn triggering that interface component 118 to be displayed (or hidden), and so on.

The display handler 121 may generate user interface data for rendering a dynamic runbook and provide the user interface display data to the display environment 106. The display handler 121 may be responsible for displaying interface components 118 in the dynamic runbook, as well as managing interactions between a user and interface components 118. The display handler 121 may cause an interface component 118 to be displayed or hidden in dynamic runbook based on instructions from the runbook generation engine 117.

Configuration of the display handler 121 may depend on the display environment 106 in which the dynamic runbook will be displayed. For example, if the display environment 106 is a webpage, the display handler 121 may be implemented to display interface components 118 using JavaScript. Different configurations of the display handler 121 may therefore enable a single dynamic runbook to be displayed in multiple different types of display environments 106 without changing the dynamic runbook's input configuration 114.

### External Service Interface

The external service interface 124 may interact with one or more external services 109. An external service interface 124 may enable the dynamic runbook to access functionality of external services 109 that a user would access manually when using a conventional, static runbook. In some implementations, a plurality of external service interfaces 124 may each enable interaction with a different external service 109. Thus, each external service interface 124 may have a specific implementation that depends on the external service 109 with which the external service interface 124 is configured to interact.

For example, an external service interface 124 may be configured to interact with an issue tracking system by obtaining information about support tickets and updating statuses or other attributes of the support tickets. As another example, an external service interface 124 may be configured to interact with an external service 109 that generates logs for the monitored system 110, including obtaining logs based on parameters such as an application identifier, a tenancy, or a time range, and filtering event logs based on a keyword or other criteria. As an additional example, an external service interface 124 may be configured to interact with an external service 109 that tracks the status of various aspects of the monitored system 110, including obtaining the health statuses of machine(s) used by the monitored system 110. To give a further example, an external service interface 124 may be configured to interact with an external service 109 that manages the monitored system's 110 code versioning, including identifying recent changes to the monitored system's 110 code.

### Display Environment

The display environment 106 may execute and display dynamic runbooks. The display environment 106 may receive user interface data defining a dynamic runbook from the display handler 121. Based on the user interface data, the display environment 106 may render a user interface representing the dynamic runbook in the display 127.

The display environment 106 may be any application or other functional component providing an environment in which a dynamic runbook may be rendered in a display 127. For example, the display environment 106 may be a webpage, an interactive notebook interface, a standalone application, a command-line interface, or any other similar functional component. The display 127 may include a liquid crystal display (LCD), touch-screen display, or other type of display device.

A user may interact with a user interface rendered by the display environment 106 to access and use dynamic runbooks. A user may interact with a user interface to access to a particular dynamic runbook; the display environment 106 may request and receive user interface data defining the dynamic runbook from the runbook generation engine 117 and render a user interface representing the dynamic runbook in the display 127. A user may interact with a user interface element corresponding to an interface component 118 to input information, select an option, or perform some other action that may cause the dynamic runbook to be modified, as discussed above in relation to the runbook generation engine 117. The display environment 106 may detect any such interactions and provide an indication of the interaction(s) to the runbook generation engine 117, which may generate and provide to the display environment 106 user interface data that reflects the modified dynamic runbook. The display environment may render the updated dynamic runbook in the display 127; the updated dynamic runbook may reflect the results of the actions performed by the user with respect to the dynamic runbook. In some implementations, the display environment 106 may enable a single dynamic runbook to be accessed and interacted with by multiple different users concurrently.

As shown in FIG. 1, the display environment 106 (and/or display 127) may, in some implementations, be remote to the computing environment 103 such that the display environment 106 receives the data defining a dynamic runbook over the network 112. In that case, the display environment 106 may be implemented in a separate computing device, including a processor-based system, such as a computer system, that may include a desktop computer, a laptop computer, a personal digital assistant, a cellular telephone, a smartphone, a set-top box, a music player, a tablet computer system, a game console, an electronic book reader, or any other device with like capability. The computing device on which the display environment 106 is implemented may also be equipped with networking capability or networking interfaces, including a localized networking or communication capability, such as a near-field communication (NFC) capability, radio-frequency identification (RFID) read or write capability, or other localized communication capability. In other implementations, however, the display environment 106 (and/or display 127) may be implemented in the computing environment 103.

### External Services

An external services 109 may represent a system or service that is external to the components of the computing environment 103 and the monitored system 110. An external service 109 may provide services and functionality to the monitored system 110, as well as to the runbook generation engine 117 and interface components 118 via the external service interface 124. For example, an external service 109 may provide various functionalities related to issue tracking, log generation, status tracking, and code versioning for the monitored system 110. The external service interface 124 may facilitate the integration and interaction of the dynamic runbook with an external service 109. Interface components 118 may interact with an external service 109 via the external service interface 124 to obtain, receive, and/or display information from the external service 109. In some examples, this information may be used to update the context 115. The external service 109 may be updated based on input from an interface component 118 via the external service interface 124. For example, the external service 109 may change the status of a support ticket to “closed” upon receiving an indication from an interface component 118 via the external service interface 124 that the issue underlying the support ticket has been resolved.

### Monitored System

The monitored system 110 may be any software application or service that is monitored by an entity such as an organization or enterprise for the occurrence of incidents or other issues related to the functionality of the monitored system 110. The monitored system 110 may be, for example, any kind of software application, cloud service or application, or platform. Dynamic runbooks may be created and used by an OCE to address incidents that occur within the monitored system 110.

### Example System for Generating Dynamic Runbook

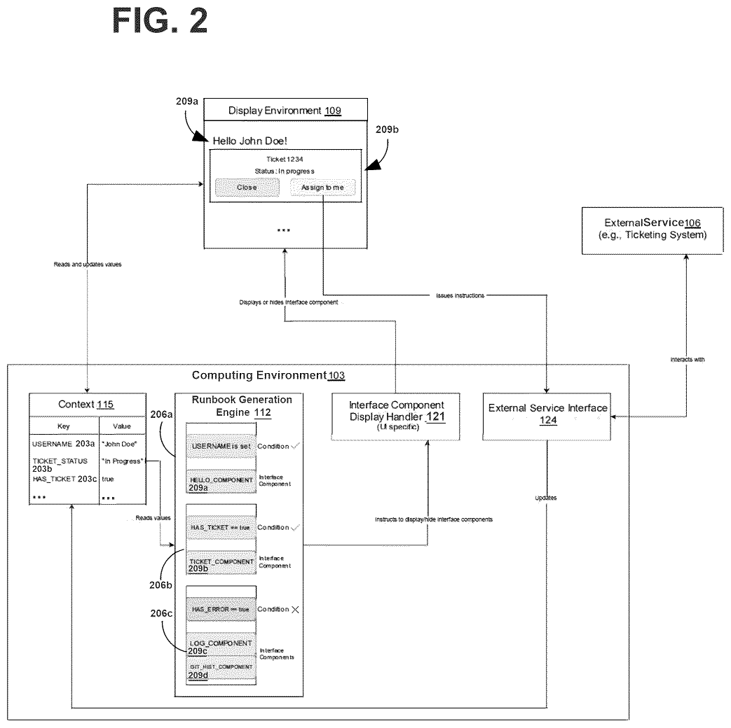

FIG. 2 is a block diagram that illustrates an example of a system for generating a dynamic runbook implemented based on the network environment 100 of FIG. 1. The system shown in merely an example, and the network environment 100 and the various components therein may be used to implement other systems having different components and functional arrangements.

The context 115 includes several context variables 116. The context variables 116 are shown as key-value pairs. As is depicted in this example, the example context variables 203a, 203b, and 203c may hold various different types of data. The USERNAME context variable 203a has a string value of “John Doe” and the TICKET_STATUS context variable 203b has a string value of “In Progress”. In contrast, the HAS_TICKET context variable 203c has a Boolean value of true.

The example of FIG. 2 shows several sequences of interface components 118. In FIG. 2, specific examples of sequences 206a, 206b, and 206c are shown as subcomponents of the runbook generation engine 117 to illustrate how the runbook generation engine 117 obtains a list of sequences when parsing an input configuration 114. Each of the sequences 206a, 206b, and 206c is associated with a particular display condition and includes one or more interface components 118, which here include example interface components 209a, 209b, and 209c. As part of their execution, any of the depicted interface components 209a, 209b, and 209c may read values from the context 115. In addition, the runbook generation engine 107 may check the values of context variables 203a, 203b, and 203c to determine whether the display condition for any of the sequences 206a, 206b, or 206c is satisfied.

A first sequence 206a has a display condition that the USERNAME context variable 203a is set. This display condition is satisfied, so the display environment 106 displays the HELLO_COMPONENT 209a in the dynamic runbook. The HELLO_COMPONENT 209a displays the string “Hello John Doe”, which includes the value of the USERNAME context variable 203a obtained from the context 115. A second sequence 206b has a display condition that the HAS_TICKET context variable 203b be set to true. Because this is indeed the case, the display environment 106 displays the TICKET_COMPONENT 209b in the dynamic runbook. A third sequence 206c has a display condition that a HAS_ERROR variable is set to true, but because the context 115 does not contain a HAS_ERROR variable set to true, the LOG_COMPONENT 209c and GIT_HIST_COMPONENT 209d are not displayed in the dynamic runbook by the display environment 106.

### Example Operation of Runbook Generation Engine

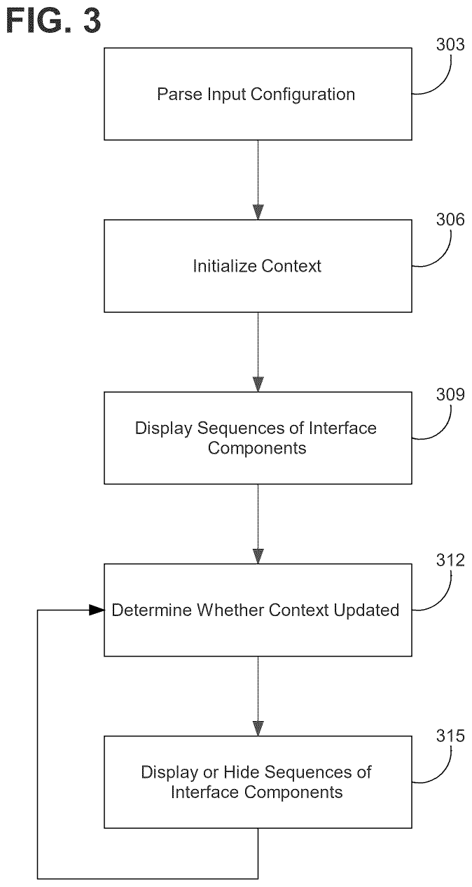

FIG. 3 is a flow diagram that depicts an example of the operation of a portion of the runbook generation engine 117, in an embodiment. The flow diagram of FIG. 3 provides merely an example of the many different types of functional arrangements that may be employed to implement the operation of the depicted portion of the runbook generation engine 117. As an alternative, the flow diagram of FIG. 3 may be viewed as depicting an example of elements of a method implemented within the network environment 100.

At step 303, the runbook generation engine 117 may parse an input configuration 114. The input configuration 114 may correspond to a dynamic runbook that the runbook generation engine 117 has been requested to generate. Based on the input configuration 114, the runbook generation engine 117 may obtain a list of sequence(s) of interface component(s) 118 and a display condition for each sequence in the list.

At step 306, the runbook generation engine 117 may initialize the context 115. The runbook generation engine 117 may initialize context variables 116 in the context 115 using a predefined set of values, for instance. This predefined set of values may represent an initial state of the dynamic runbook. In some implementations, the predefined set of values may be defined in the input configuration 114.

At step 309, the runbook generation engine 117 may instruct the display handler 121 to display one or more sequences of interface components 118. The runbook generation engine 117 may identify any sequence of interface components 118 having a display condition that is currently satisfied. The runbook generation engine 117 may also determine whether any currently displayed sequence of interface components 118 has a display condition that is no longer satisfied. Such a display condition may, for instance, specify one of the predefined set of values with which the context 115 was initialized. In some examples, however, the runbook generation engine 117 may first cause display of any “starting” sequences of interface components 118 that do not have a display condition.

At step 312, the runbook generation engine 117 may check the context 115 to determine whether any of the context variables 116 have been updated. The context variables 116 may be updated by one or more interface components 118 in various situations.

The context 115 may be updated when a specific interface component 118 is displayed. For example, a support ticket interface component 118 may update context variables 116 associated with a support ticket from their initial (possibly placeholder) values to reflect a current state of the support ticket.

The context 115 may also be updated when a user provides an input to an interface component 118. As an example, a user could input a username into a text input field provided by a login interface component 118, and the login interface component 118 could update a “username” context variable 116 accordingly.

In addition, the context 115 may be updated when an interface component 118 causes the external service interface 124 to interact with an external service 109. For instance, a user may request that an interface component 118 retrieve information on incidents that occurred in a given time range. Upon receiving this information (via the external service interface 124) from an external service 109 that tracks incidents, the interface component 118 may update the context 115 to reflect the occurrence of any such incidents.

Further, the context 115 may be updated periodically, such as when an interface component 118 periodically fetches up-to-date data from an external service 109. To illustrate, an interface component 118 may obtain the most recent entries from an event log from a logging external service 109 every second, and the interface component may update the context 115 if some particular event occurred.

At step 315, the runbook generation engine 117 may display or hide any sequences of interface components 118 based on the updated context 115, if applicable. In some implementations, the process may then proceed back to step 312 to wait for further updates to the context 115.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

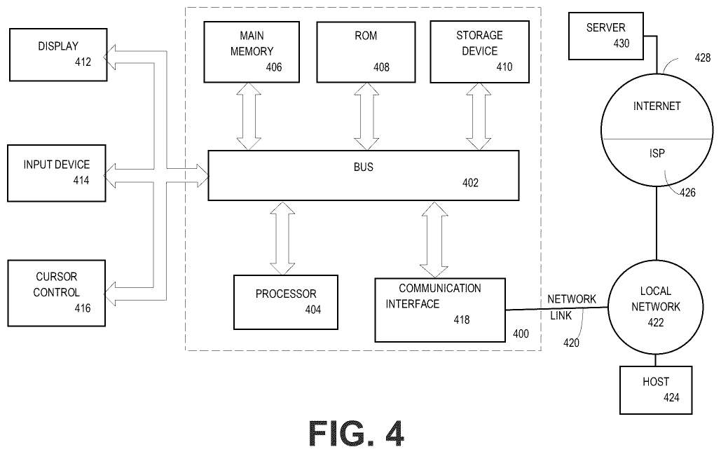

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### Software Overview

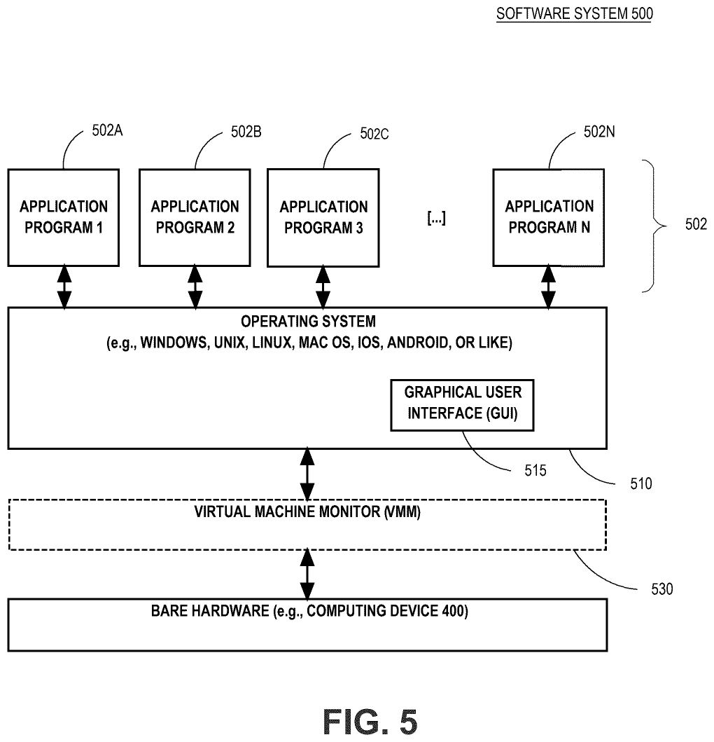

FIG. 5 is a block diagram of a basic software system 500 that may be employed for controlling the operation of computing system 400. Software system 500 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 500 is provided for directing the operation of computing system 400. Software system 500, which may be stored in system memory (RAM) 406 and on fixed storage (e.g., hard disk or flash memory) 410, includes a kernel or operating system (OS) 510.

The OS 510 manages low-level aspects of computer operation, including managing execution of processes, memory allocation, file input and output (I/O), and device I/O. One or more application programs, represented as 502A, 502B, 502C . . . 502N, may be “loaded” (e.g., transferred from fixed storage 410 into memory 406) for execution by the system 500. The applications or other software intended for use on computer system 400 may also be stored as a set of downloadable computer-executable instructions, for example, for downloading and installation from an Internet location (e.g., a Web server, an app store, or other online service).

Software system 500 includes a graphical user interface (GUI) 515, for receiving user commands and data in a graphical (e.g., “point-and-click” or “touch gesture”) fashion. These inputs, in turn, may be acted upon by the system 500 in accordance with instructions from operating system 510 and/or application(s) 502. The GUI 515 also serves to display the results of operation from the OS 510 and application(s) 502, whereupon the user may supply additional inputs or terminate the session (e.g., log off).

OS 510 can execute directly on the bare hardware 520 (e.g., processor(s) 404) of computer system 400. Alternatively, a hypervisor or virtual machine monitor (VMM) 530 may be interposed between the bare hardware 520 and the OS 510. In this configuration, VMM 530 acts as a software “cushion” or virtualization layer between the OS 510 and the bare hardware 520 of the computer system 400.

VMM 530 instantiates and runs one or more virtual machine instances (“guest machines”). Each guest machine comprises a “guest” operating system, such as OS 510, and one or more applications, such as application(s) 502, designed to execute on the guest operating system. The VMM 530 presents the guest operating systems with a virtual operating platform and manages the execution of the guest operating systems.

In some instances, the VMM 530 may allow a guest operating system to run as if it is running on the bare hardware 520 of computer system 500 directly. In these instances, the same version of the guest operating system configured to execute on the bare hardware 520 directly may also execute on VMM 530 without modification or reconfiguration. In other words, VMM 530 may provide full hardware and CPU virtualization to a guest operating system in some instances.

In other instances, a guest operating system may be specially designed or configured to execute on VMM 530 for efficiency. In these instances, the guest operating system is “aware” that it executes on a virtual machine monitor. In other words, VMM 530 may provide para-virtualization to a guest operating system in some instances.

A computer system process comprises an allotment of hardware processor time, and an allotment of memory (physical and/or virtual), the allotment of memory being for storing instructions executed by the hardware processor, for storing data generated by the hardware processor executing the instructions, and/or for storing the hardware processor state (e.g. content of registers) between allotments of the hardware processor time when the computer system process is not running. Computer system processes run under the control of an operating system, and may run under the control of other programs being executed on the computer system.

### Cloud Computing

The term “cloud computing” is generally used herein to describe a computing model which enables on-demand access to a shared pool of computing resources, such as computer networks, servers, software applications, and services, and which allows for rapid provisioning and release of resources with minimal management effort or service provider interaction.

A cloud computing environment (sometimes referred to as a cloud environment, or a cloud) can be implemented in a variety of different ways to best suit different requirements. For example, in a public cloud environment, the underlying computing infrastructure is owned by an organization that makes its cloud services available to other organizations or to the general public. In contrast, a private cloud environment is generally intended solely for use by, or within, a single organization. A community cloud is intended to be shared by several organizations within a community; while a hybrid cloud comprise two or more types of cloud (e.g., private, community, or public) that are bound together by data and application portability.

Generally, a cloud computing model enables some of those responsibilities which previously may have been provided by an organization's own information technology department, to instead be delivered as service layers within a cloud environment, for use by consumers (either within or external to the organization, according to the cloud's public/private nature). Depending on the particular implementation, the precise definition of components or features provided by or within each cloud service layer can vary, but common examples include: Software as a Service (SaaS), in which consumers use software applications that are running upon a cloud infrastructure, while a SaaS provider manages or controls the underlying cloud infrastructure and applications. Platform as a Service (PaaS), in which consumers can use software programming languages and development tools supported by a PaaS provider to develop, deploy, and otherwise control their own applications, while the PaaS provider manages or controls other aspects of the cloud environment (i.e., everything below the run-time execution environment). Infrastructure as a Service (IaaS), in which consumers can deploy and run arbitrary software applications, and/or provision processing, storage, networks, and other fundamental computing resources, while an IaaS provider manages or controls the underlying physical cloud infrastructure (i.e., everything below the operating system layer). Database as a Service (DBaaS) in which consumers use a database server or Database Management System that is running upon a cloud infrastructure, while a DbaaS provider manages or controls the underlying cloud infrastructure and applications.

The above-described basic computer hardware and software and cloud computing environment presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
parsing an input configuration that specifies a plurality of interface component sequences;
initializing a context comprising a plurality of context variables;
generating a dynamic runbook based at least in part on the input configuration and the context;
modifying a value of a particular context variable from the context to comprise an updated value; and
in response to modifying the value of the particular context variable, modifying the dynamic runbook to comprise one or more interface components corresponding to one or more of the plurality of interface component sequences,
wherein the method is performed by one or more computing devices.

2. The method of claim 1, wherein the value of the particular context variable is modified in response to:
the dynamic runbook being updated to comprise a particular interface component;
receiving user input via the one or more interface components;
an interaction with an external service; or
an elapsing of a predetermined period of time.

3. The method of claim 1, wherein the one or more interface components are one or more first interface components, the one or more of the plurality of interface component sequences are one or more first interface component sequences, and the method further comprises:
in response to modifying the particular context variable, updating the dynamic runbook to exclude one or more second interface components corresponding to one or more second interface components sequences of the plurality of interface component sequences.

4. The method of claim 1, wherein generating the dynamic runbook based at least in part on the input configuration and the context comprises including, in the dynamic runbook, one or more initial interface components corresponding to an initial interface component sequence of the plurality of interface components sequences.

5. The method of claim 1, further comprising interacting with an external service in response to receiving user input via the one or more interface components.

6. The method of claim 1, wherein the one or more of the plurality of interface component sequences are associated with a display condition that specifies the updated value.

7. The method of claim 6, further comprising:
determining that the particular context variable has been modified; and
identifying the one or more of the plurality of interface component sequences as being associated with the display condition that specifies the updated value.

8. The method of claim 1, wherein the context comprises a key-value store, and individual context variables of the plurality of context variables comprise a key-value pair.

9. The method of claim 1, wherein the one or more interface components comprise at least one of:
a text field configured to receive user input, or
a container configured to display data obtained from an external service.

10. The method of claim 1, wherein modifying the dynamic runbook to comprise the one or more interface components corresponding to one or more of the plurality of interface component sequences further comprises:
generating user interface data defining a user interface representing the dynamic runbook, wherein the user interface comprises one or more user interface elements corresponding to the one or more of the plurality of interface component sequences; and
providing the user interface data to a display environment.

11. One or more non-transitory, computer-readable storage media storing instructions that, when executed by one or more processors, cause:
parsing an input configuration that specifies a plurality of interface component sequences;
initializing a context comprising a plurality of context variables;
generating a dynamic runbook based at least in part on the input configuration and the context;
modifying a value of a particular context variable from the context to comprise an updated value; and
in response to modifying the value of the particular context variable, modifying the dynamic runbook to comprise one or more interface components corresponding to one or more of the plurality of interface component sequences.

12. The one or more non-transitory, computer-readable storage media of claim 11, wherein the value of the particular context variable is modified in response to:
the dynamic runbook being updated to comprise a particular interface component;
receiving user input via the one or more interface components;
an interaction with an external service; or
an elapsing of a predetermined period of time.

13. The one or more non-transitory, computer-readable storage media of claim 11, wherein the one or more interface components are one or more first interface components, the one or more of the plurality of interface component sequences are one or more first interface component sequences, and the instructions, when executed by the one or more processors, further cause:
in response to modifying the particular context variable, updating the dynamic runbook to exclude one or more second interface components corresponding to one or more second interface components sequences of the plurality of interface component sequences.

14. The one or more non-transitory, computer-readable storage media of claim 11, wherein generating the dynamic runbook based at least in part on the input configuration and the context comprises including, in the dynamic runbook, one or more initial interface components corresponding to an initial interface component sequence of the plurality of interface components sequences.

15. The one or more non-transitory, computer-readable storage media of claim 11, wherein the instructions, when executed by the one or more processors, further cause interacting with an external service in response to receiving user input via the one or more interface components.

16. The one or more non-transitory, computer-readable storage media of claim 11, wherein the one or more of the plurality of interface component sequences are associated with a display condition that specifies the updated value.

17. The one or more non-transitory, computer-readable storage media of claim 16, wherein the instructions, when executed by the one or more processors, further cause:
determining that the particular context variable has been modified; and
identifying the one or more of the plurality of interface component sequences as being associated with the display condition that specifies the updated value.

18. The one or more non-transitory, computer-readable storage media of claim 11, wherein the context comprises a key-value store, and individual context variables of the plurality of context variables comprise a key-value pair.

19. The one or more non-transitory, computer-readable storage media of claim 11, wherein the one or more interface components comprise at least one of:
a text field configured to receive user input, or
a container configured to display data obtained from an external service.

20. The one or more non-transitory, computer-readable storage media of claim 11, wherein modifying the dynamic runbook to comprise the one or more interface components corresponding to one or more of the plurality of interface component sequences further comprises:
generating user interface data defining a user interface representing the dynamic runbook, wherein the user interface comprises one or more user interface elements corresponding to the one or more of the plurality of interface component sequences; and
providing the user interface data to a display environment.
